(19) United States
(12) Patent Application Publication
(10) Pub. No.: US 2006/0117524 A1
(43) Pub. Date: Jun. 8, 2006

(54) Structure of a shock absorbing caster

(76) Inventor: Li-Lan Yan, Puzih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/004,941

(22) Filed: Dec. 7, 2004

(51) Int. Cl. B60B 33/00

(52) U.S. Cl. 16/44

(57) ABSTRACT

A caster includes a connecting part, a rotary support, a fork, a wheel, upper and lower springs, and a connecting stick; the connecting part is secured to a bottom side of a piece of furniture; the rotary support is arranged under and connected to the connecting part; the fork is arranged under and pivoted to the rotary support while the wheel is connected to the fork; the lower spring is positioned under an upper portion of the fork while the upper spring is positioned between the upper portion of the fork and the rotary support; the connecting stick is passed through the lower spring, the upper portion of the fork, and the upper spring in sequence, and securely connected to the rotary support at an upper end; thus, the upper and the lower springs will reduce upward and downward jolts respectively while the furniture is being moved along a rugged land.

### BACKGROUND OF THE INVENTION

1. Field of the invention

The present invention relates to a shock absorbing caster, more particularly one, which is structured in such a way that upward and downward jolts of a piece of furniture, which is equipped with the caster, can be effectively reduced while the furniture is being moved along a rugged land.

2. Brief Description of the Prior Art

Referring to FIGS. 1 to 3, a conventional shock absorbing caster includes a connecting part 10, a rotary support 20, a fork 30, a wheel 301, and an elastic element 40.

The connecting part 10 is secured to a bottom of a piece of furniture such as a trolley. The rotary support 20 is connected to the connecting part 10 so as to be capable of turning. The fork 30 is pivoted to the rotary support 20 while the wheel 301 is connected to the fork 30. The elastic element 40 is pressed against the rotary support 20 at one end, and the fork 30 at the other.

Thus, the elastic element 40 will be compressed to help reduce violent downward jolt of the furniture while the furniture is being moved along a rugged land.

Referring to FIGS. 4 and 5, another conventional shock absorbing caster includes a connecting part 10, a rotary support 20, a fork 30, a wheel 301, a pair of arms 50, and a pair of shock absorbing members 60, which can be elastic elements or hydraulic shock absorbers.

The connecting part 10 is secured to a bottom of a piece of furniture such as a trolley. The rotary support 20 is connected to the connecting part 10 so as to be capable of turning. The fork 30 is pivoted to the rotary support 20 while the wheel 301 is connected to the fork 30. The arms 50 are respectively pivoted to two lateral sides of the rotary support 20, and each has a pivotal protrusion 501. The shock absorbing members 60 are pivoted to respective ones of the protrusions 501 of the arms 50 at upper ends thereof, and they are connected to an axle of the wheel 301 in an angularly displaceable manner. Therefore, the shock absorbing members 60 will be compressed to absorb violent downward jolt of the piece of furniture while the furniture is being moved along a rugged land.

However, the above casters are found to have a disadvantage: the elastic element 40 and the shock absorbing members 60 can only reduce violent downward jolt of the furniture, which will occur while the caster is moving downward from an upper edge of a cavity of a rugged land to the bottom of the cavity; the elastic element 40 and the shock absorbing members 60 will stretch from the compressed position and release the power stored therein during the course of the casters moving upwards from a bottom of a cavity to an upper edge of the cavity, thus causing even more violent upward jolt of the furniture instead of reducing the jolt. Consequently, the furniture can get damaged, and the objects held thereon can fall over.

### SUMMARY OF THE INVENTION

It is a main object of the invention to provide an improvement on a shock absorbing caster to overcome the above disadvantage.

The caster of the present invention includes a connecting part, a rotary support, a fork, a wheel, and upper and lower springs, and a connecting stick, which upper and lower springs are respectively used for reducing upward and downward jolts of a piece of furniture equipped with the caster. The connecting part is secured to a bottom side of a piece of furniture. The rotary support is arranged under and connected to the connecting part while the fork is arranged under and pivoted to the rotary support. The wheel is connected to the fork. The lower spring is positioned under an upper portion of the fork while the upper spring is positioned between the upper portion of the fork and the rotary support. And, the connecting stick is passed through the lower spring, the upper portion of the fork, and the upper spring in sequence, and securely connected to the rotary support at an upper end.

### BRIEF DESCRIPTION OF THE DRAWINGS

The present invention will be better understood by referring to the accompanying drawings, wherein:

FIG. 1 is a perspective view of the first conventional caster,

FIG. 2 is a vertical section of the first conventional caster,

FIG. 3 is a vertical section of the first conventional caster, moving on a rugged land,

FIG. 4 is an exploded perspective view of the second conventional shock absorbing caster,

FIG. 5 is a vertical section of the second conventional caster,

FIG. 6 is an exploded perspective view of the present caster,

FIG. 7 is a vertical section of the present caster,

FIG. 8 is a vertical section of the present caster in motion, and

FIG. 9 is a vertical section of the present caster, with the brake mechanism being in the depressed in-use position.

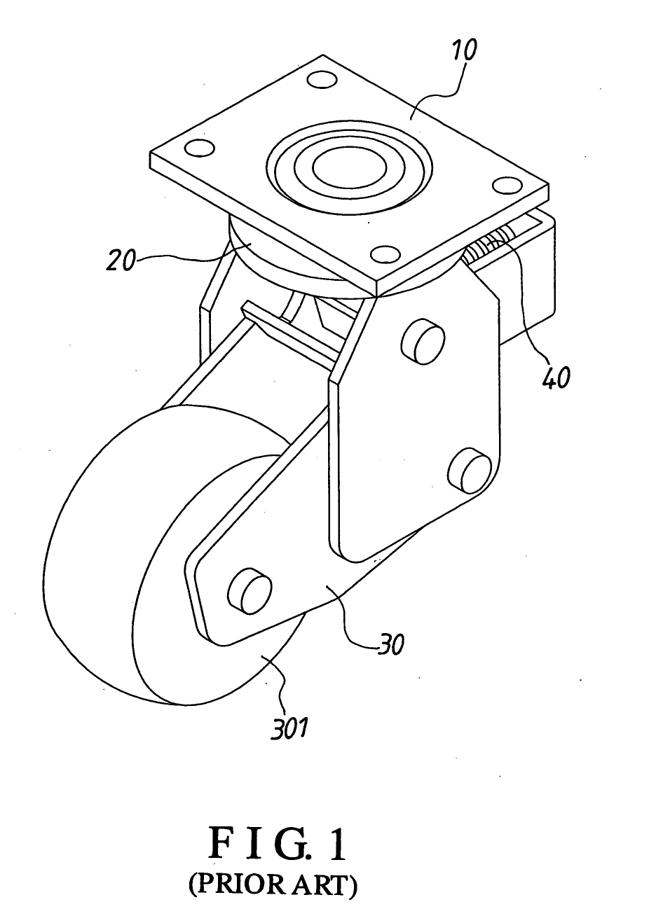

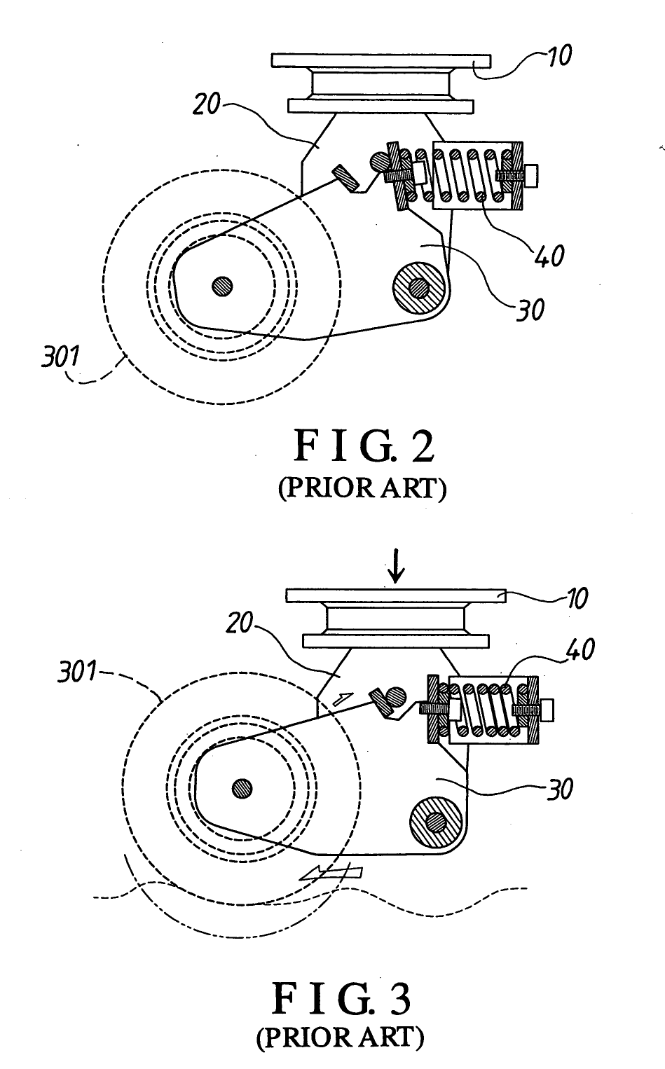

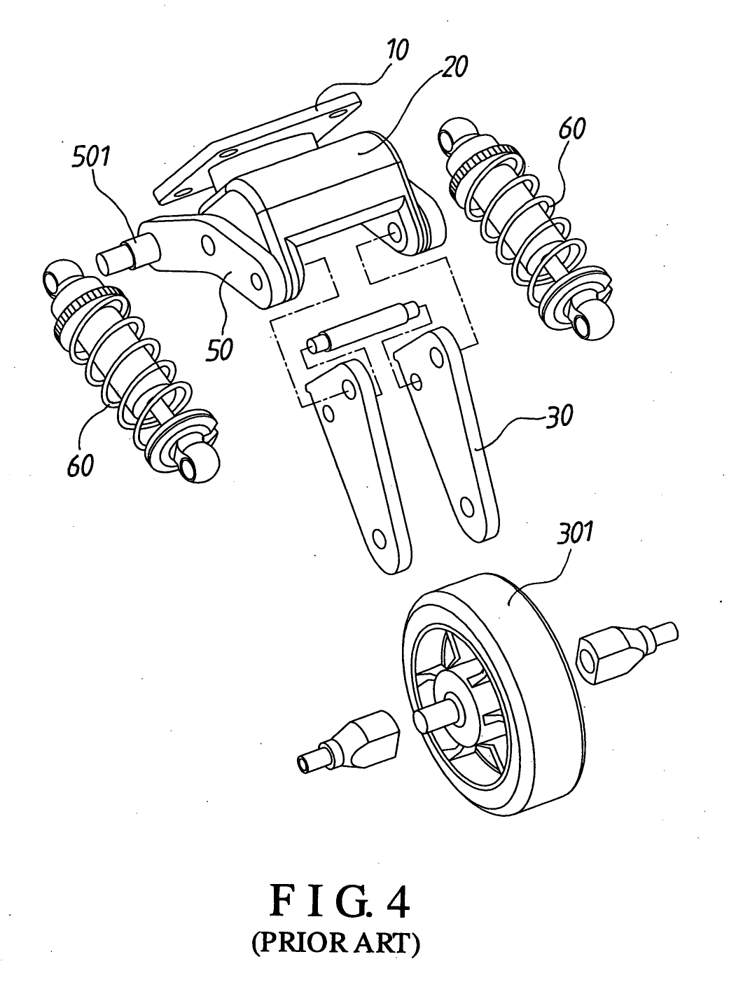

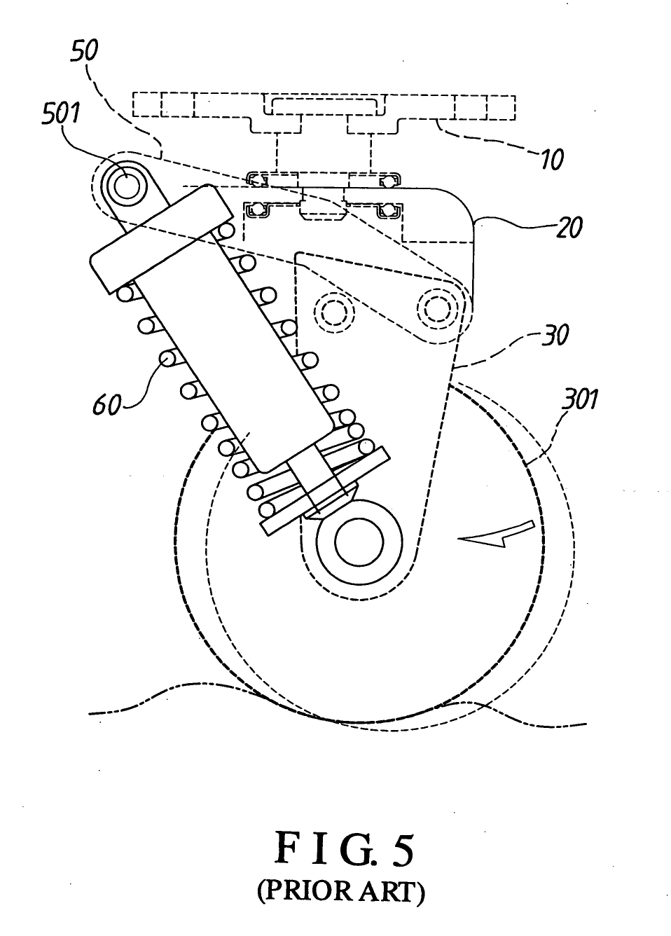

### DETAILED DESCRIPTION OF THE PREFERRED EMBODIMENTS

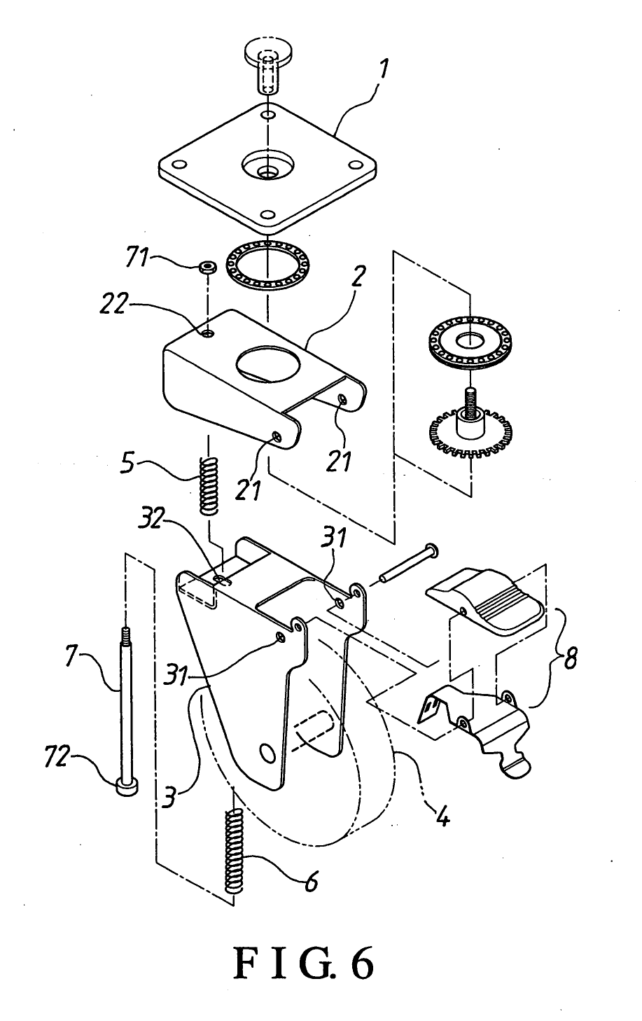

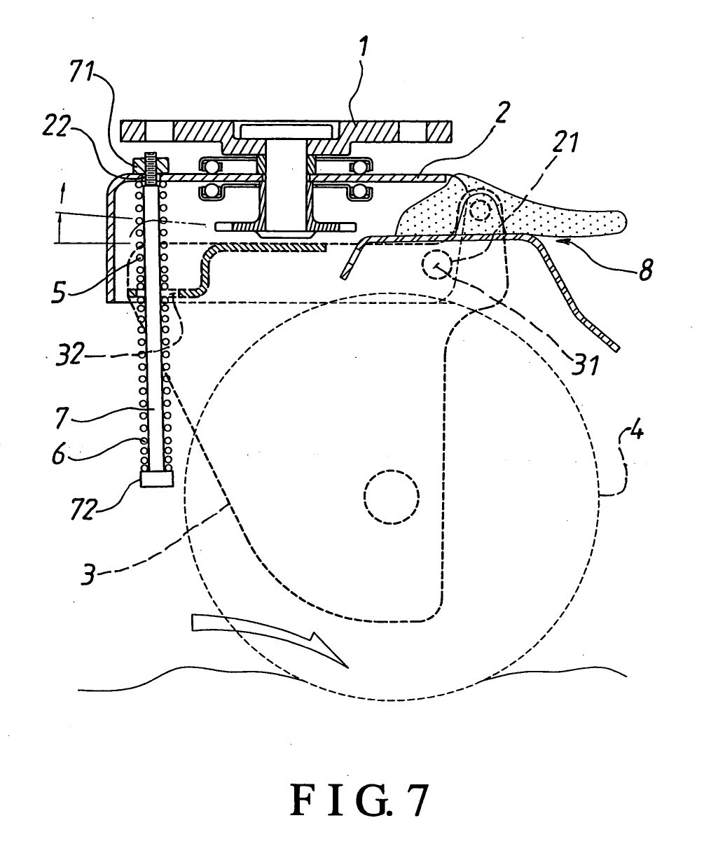

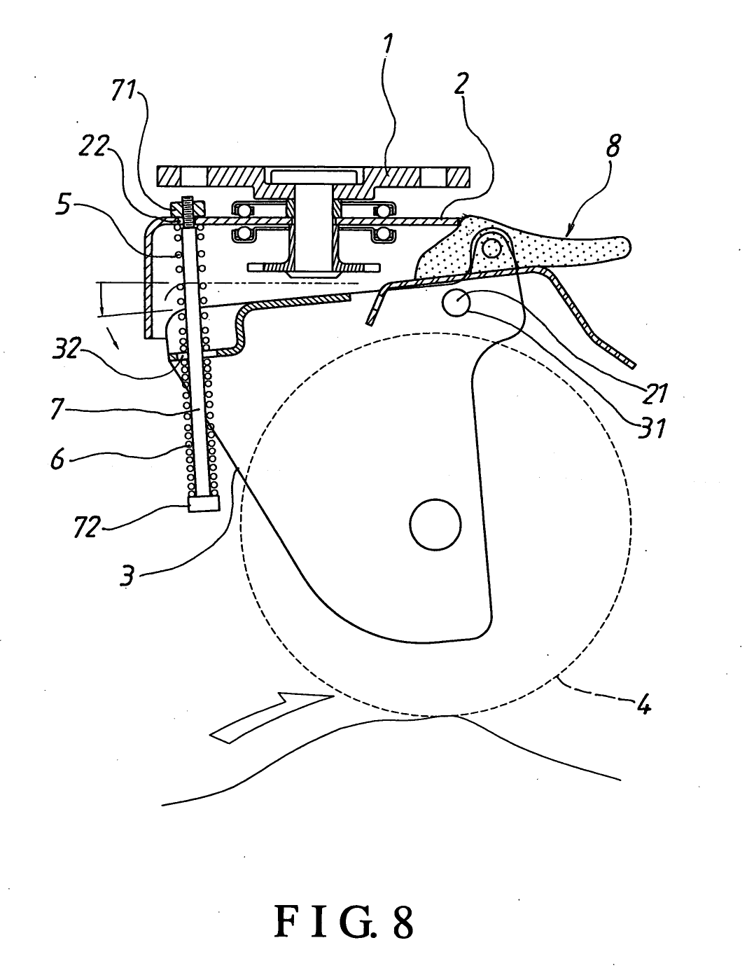

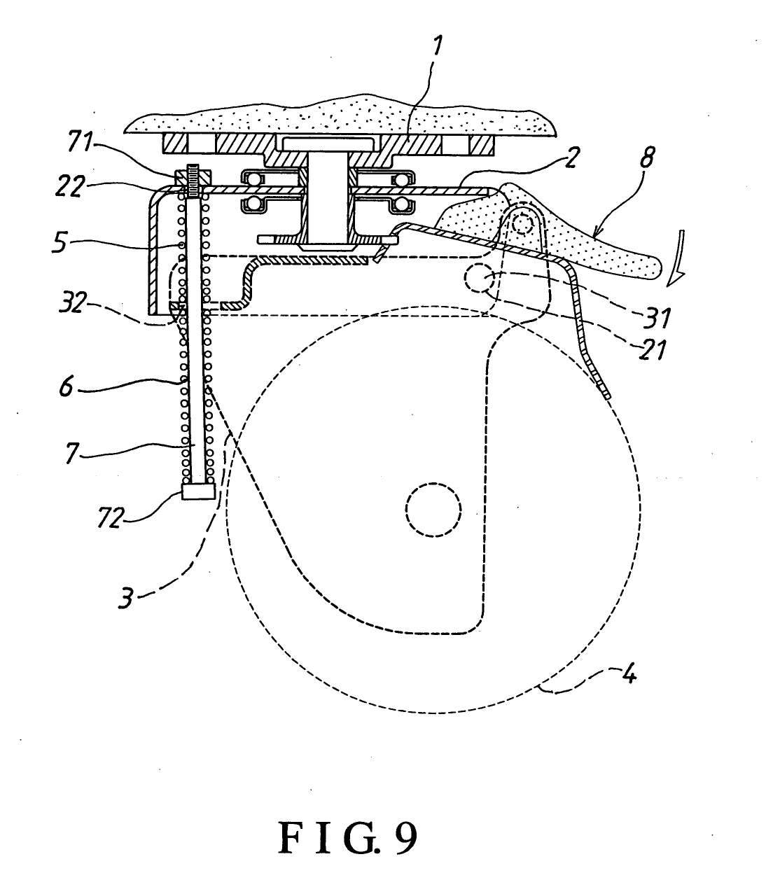

Referring to FIGS. 6 and 9, a preferred embodiment of a shock absorbing caster of the invention includes a connecting part 1, a rotary support 2, a fork 3, a wheel 4, an upper elastic element 5, a lower elastic element 6, a connecting stick 7, and a brake mechanism 8.

The connecting part 1 is secured to a bottom of a piece of furniture such as a trolley.

The rotary support 2 is connected to the connecting part 1 so as to be capable of turning, and it has a pivotal portion 21 at one end, and a through hole 22 extending from an upper side to a lower side of the other end.

The fork 3 has a pivotal portion 31 at one end, and a slot 32 extending from an upper side to a lower side of the other end. The fork 3 is pivoted to the pivotal portions 21 of the rotary support 2 at the pivotal portion 31 thereof while the wheel 4 is connected to the fork 3.

The connecting stick 7 has a rim 72 at a lower end, and screw threads at an upper end thereof, and it is passed through the lower elastic element 6, the slot 32 of the fork 3, the upper elastic element 5, and the through hole 22 of the rotary support 2 in sequence, and screwed into a nut 71; thus, the lower elastic element 6 is pressed against the rim 72 and the upper portion of the fork 3 at two ends thereof while the upper elastic element S is pressed against the rotary support 2 and the upper portion of the fork 3 at two ends thereof. The brake mechanism 8 is pivoted to the pivotal portion 31 of the fork 3 such that it can be forced to touch the wheel 4 for making the wheel incapable of turning.

Therefore, while the caster is moving downwards from an upper edge of a cavity of a rugged land to a bottom of the cavity, the lower elastic element 6 will be compressed to reduce violent downward jolt of the furniture. And, while the caster is moving upwards from a bottom of a cavity of a rugged land to an upper edge of the cavity, the lower elastic element 6 will stretch from the compressed position and release the power stored therein, and the upper elastic element 5 will be compressed so as to counteract the lower elastic element 6, thus reducing violent upward jolts of the furniture. Consequently, the furniture can move along a rugged land with reduced risk of objects held thereon getting damaged or falling over.

From the above description, it can be easily understood that the shock absorbing caster of the invention has an advantage: besides having the lower elastic element 6 for reducing violent downward jolt of the furniture, the caster is equipped with the upper elastic element 5, which can reduce a violent upward jolt occurring while the furniture is being moved along a rugged land. Therefore, the present caster is more ideal than the conventional ones described in Background.

What is claimed is:

1. A shock absorbing caster, comprising a rotary support arranged under a bottom of a piece of furniture;
a fork member arranged under and pivoted to the rotary support;
a wheel connected to the fork member;
a lower elastic element positioned under an upper portion of the fork member;
an upper elastic element positioned between the upper portion of the fork member and the rotary support; and
a connecting stick; the stick being passed through the lower elastic element, the upper portion of the fork member, and the upper elastic element in sequence, and securely connected to the rotary support at an upper end for allowing the upper and the lower elastic elements to respectively reduce upward and downward jolts while the furniture is being moved along a rugged land.

2. The shock absorbing caster as claimed in claim 1 further having an upper part secured to the bottom of the furniture, to which the rotary support is connected.

3. The shock absorbing caster as claimed in claim 1 further having a brake mechanism pivoted to the fork member.

4. The shock absorbing caster as claimed in claim 1, wherein the upper portion of the fork member is formed with a slot thereon, through which the connecting stick is passed.

5. The shock absorbing caster as claimed in claim 1, wherein the connecting stick has a rim at a lower end, and a threaded upper end, which screwed into a nut on the rotary support, while the lower elastic element is pressed against the rim at a lower end.
